(19) United States
(12) Patent Application Publication
(10) Pub. No.: US 2005/0046416 A1
(43) Pub. Date: Mar. 3, 2005

(54) Transducer

(76) Inventor: Ian P. Harris, Dorset (GB)

Correspondence Address: WELLS ST. JOHN P.S., 601 W. FIRST AVENUE, SUITE 1300, SPOKANE, WA, 99201, US

(21) Appl. No.: 10/922,489

(22) Filed: Aug. 19, 2004

(30) Foreign Application Priority Data
Aug. 22, 2003 (GB) 0319694.6

(51) Int. Cl. G01B 7/14

(52) U.S. Cl. 324/207.24

(57) ABSTRACT

A transducer for producing an output indicative of an axial displacement comprises a housing having an axis with a core member which is axially moveable within housing. Wound around the outer surface of the housing is a primary winding comprising turns of an electrical conductor, and at least one secondary winding, comprising turns of a further electrical conductor. An AC signal supplied to the primary winding induces an output signal in the secondary winding dependent upon a position of the core member. The secondary winding has an axial distribution of turns such that the output signal induced is indicative of a trigonometric function of the axial displacement of the core member within the housing.

The present invention relates to a transducer for producing an output signal indicative of a displacement.

Rotary resolvers are known which provide an electrical output signal indicative of an angular displacement of a shaft member of the resolver. The size of the output signal (typically a voltage) is proportional to the angular displacement of the shaft. Such resolvers are commonly used in engine fuel systems for detecting displacement of a component such as a valve member. A rack and pinion (or similar) system is used to couple the component to the resolver such that a linear displacement of the component causes rotation of the shaft member.

The mechanical coupling and movement of these rotary resolvers occurs within the fuel system enclosure of the engine and is subject to fuel pressure. This causes a problem because the electrical components that generate the signal must also be housed within the fuel system and so come into contact with the fuel. Some fuels are corrosive in nature and seriously restrict the safe operating life of the electrical components. Alternatively, the resolver shaft may include a rotary seal so that movement of the shaft can be detected from outside the fuel enclosure. The design of such seals is problematic in high pressure fuel systems. Nevertheless, rotary resolvers have become established as transducers for use in fuel control systems.

It is an aim of the present invention to provide an axial displacement transducer having an output characteristic equivalent to that of a rotary resolver, but which substantially alleviates the aforementioned problems.

According to the present invention there is provided a transducer comprising:

a core member moveable along a path;

a primary winding; and

at least one secondary winding,

whereby an AC signal supplied to said primary winding induces an output signal in said secondary winding dependent upon the position of said core member along said path,

wherein said windings comprise turns of electrical conductors distributed relative to one another such that said output signal induced is indicative of a trigonometric function of the displacement of said core member along said path.

Preferably, the core member is of a magnetically permeable material so as to enhance inductive coupling of the primary and secondary windings.

The trigonometric function may be a sine or a cosine function. The output signal therefore contains an indication of an angle corresponding to the displacement of the member along the path. The transducer thereby mimics the output of a rotary resolver.

The moveable core member may be situated within an enclosure, with the windings wound around the outside of the enclosure. The enclosure may be a high pressure fluid enclosure. It is an advantage that where the electrical conductors of the windings are situated outside the enclosure so that they neither come into contact with the fluid, nor is there any requirement to provide a fluid seal on the moving components. The angular displacement function provides for use in an existing control system designed for conventional rotary resolvers.

In a preferred embodiment, the transducer has a first secondary winding configured to provide an output indicative of a sine function of the displacement of the core member, and a second secondary winding configured to provide an output indicative of a cosine function of the displacement of the core member.

Advantageously, the sine function and the cosine function are combined to provide a transfer function output signal. The transfer function may be arctan (sine/cosine). This provides an output which is directly proportional to the angle (degrees or radians) corresponding to displacement of the core member. It is a further advantage that the use of a transfer function reduces the effects of electrical supply and temperature variations because changes that are proportional to both sine and cosine cancel each other.

The first and second secondary windings may be extended to provide output signals over four or more quadrants of the trigonometric functions. An advantage of this arrangement is that the output is not limited to displacements corresponding to 360 degrees of rotation or less, but may represent (i.e. provide an output equivalent to) any angle of rotation or any number of cycles.

A further secondary winding, or pair of secondary windings, may be included in addition to the first and second secondary windings so as to provide a further output signal to indicate in which rotational equivalent cycle (i.e. set of 4 quadrants) the core member is located.

An embodiment of the invention will now be described with reference to the accompanying drawings, in which:

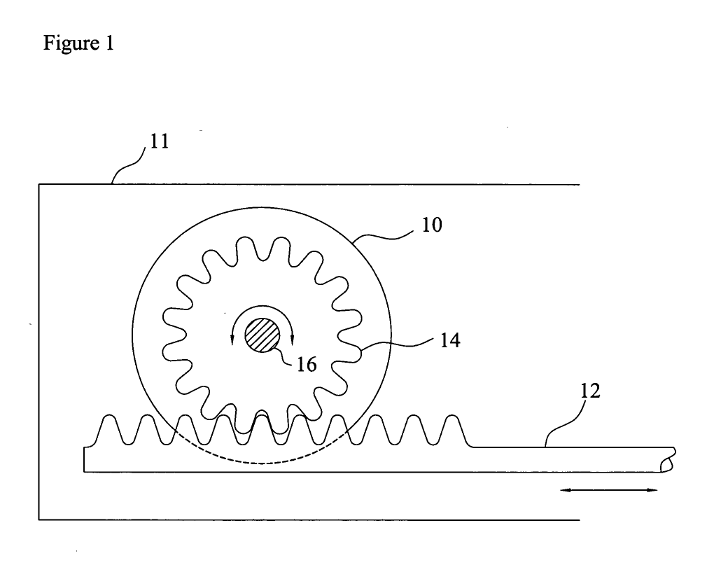

FIG. 1 shows a known rotary resolver type transducer;

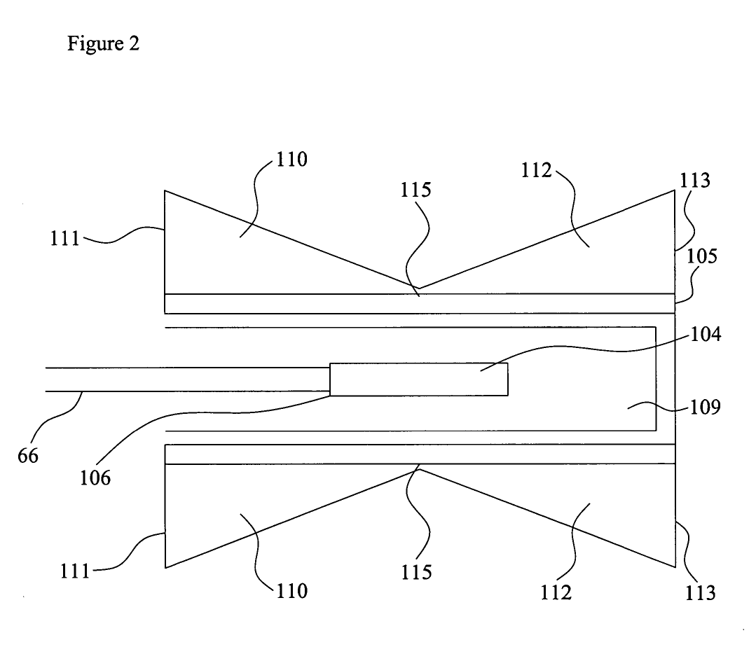

FIG. 2 is a sectional view of part of a known LVDT;

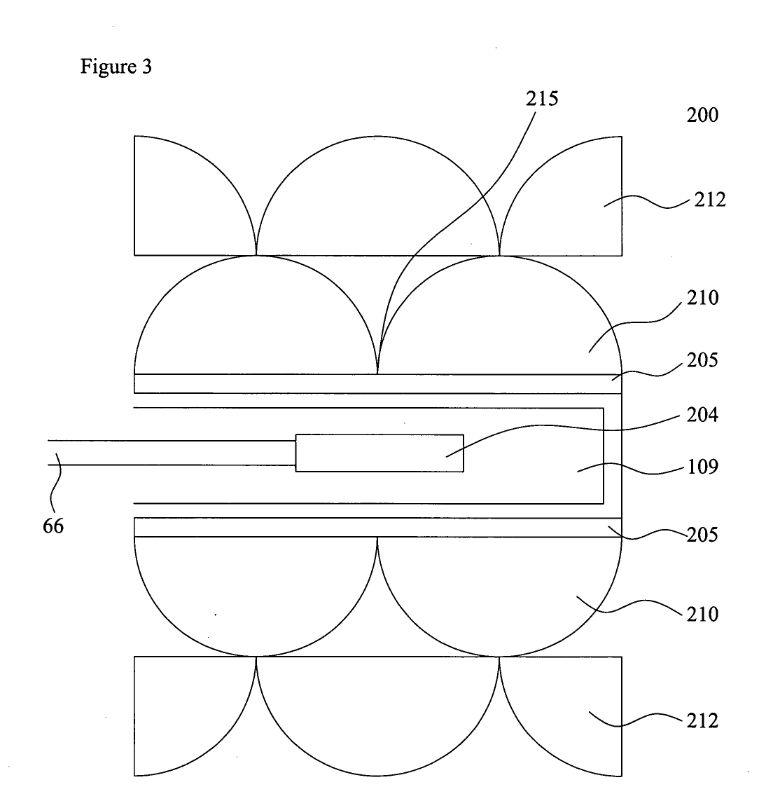

FIG. 3 is a sectional view of part of a transducer according to the present invention;

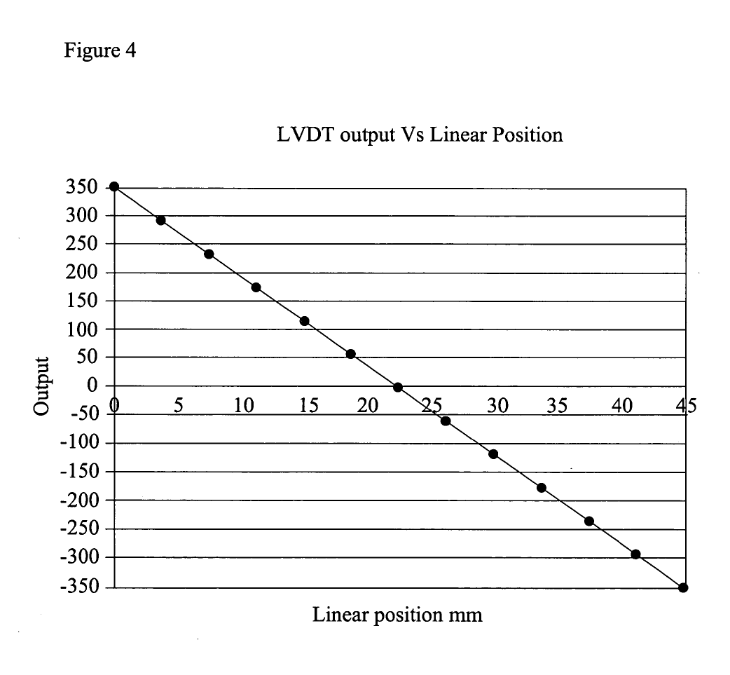

FIG. 4 is a graph showing an output voltage characteristic for the LVDT of FIG. 2;

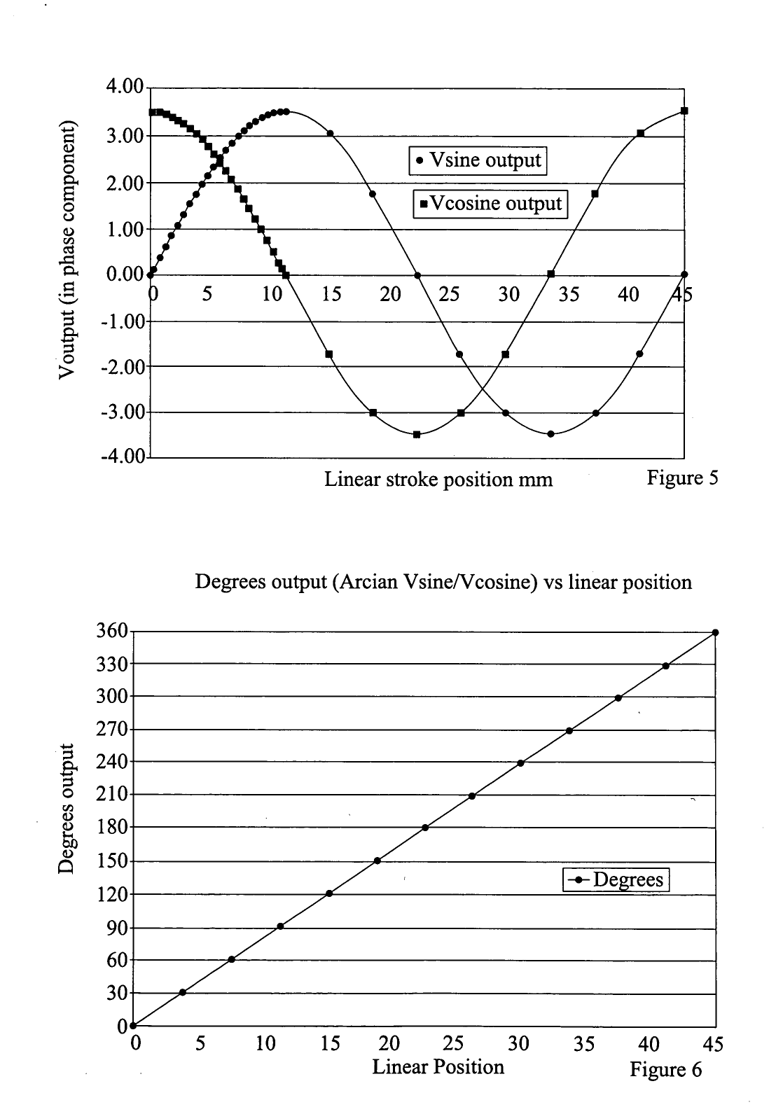

FIG. 5 is a graph showing output voltage characteristics for the transducer of FIG. 3; and

FIG. 6 is a graph showing a transfer function characteristic for the transducer of FIG. 3.

FIG. 1 shows a known rotary resolver 10 housed in an enclosure 11, forming part of a pressurised fuel system. The rotary resolver 10 is coupled to a component (not shown), such as a valve member by means of a rack 12 and pinion 14. Movement of the component causes a linear displacement of the rack 12 which drives the pinion 14 causing rotation of a shaft member 16 of the rotary resolver 10. The resolver 10 includes an electrical transducer (not shown), which provides an output voltage signal proportional to the angular displacement of the shaft 16.

The disadvantage of the system 10 of FIG. 1 is that engine fuel, which may be of a corrosive nature, is allowed to come into contact with the electrical parts of the transducer. These components are therefore likely to be damaged, hence limiting the life of the system or at least increasing the frequency with which components must be replaced.

Alternatively the resolver shaft 16 may include a rotary seal (not shown) so that movement of the shaft 16 can be detected from outside the fuel enclosure 18 to avoid contact between the electrical components and the fuel. However, the design of such seals is problematic in high pressure fuel systems.

FIG. 2 shows the construction of a known LVDT for producing an output signal indicative of an axial displacement of a shaft member 66. The LVDT 102 includes a core member 104 of a magnetically permeable material, which is connected at an end 106 thereof to a shaft 66 and is disposed so as to be axially moveable within a tube 109. The core member 104 is of a cylindrical form and has a length less than that of the entire LVDT 102 thereby permitting bi-directional axial movement of the core 104 within the tube 109.

The LVD T 102 has a primary winding 105 in the form of a wire coil wound around an outer surface of the tube 109. The LVDT 102, core member 104, tube 109 and primary winding 105 are all cylindrically symmetrical about the axis of the shaft 66. Secondary windings 110, 112 are wound around, and radially outwardly of the primary winding 105.

The primary winding 105 is wound around the tube 109 in a uniform manner along the length of the LVDT 102. A first of the secondary windings 110 begins from a proximal end face 111 of the LVDT 102 with a large number of turns perpendicular to the axis, and terminates at an intermediate position 115 with very few turns. A second of the secondary windings 112 begins from a distal end face 113 of the LVDT 102 with a large number of windings perpendicular to the axis, and terminates at the intermediate position 115 with very few windings. This gives the combined secondary windings 110, 112 a shape resembling two conical frusta placed crown to crown. The first of the secondary windings 110 is wound in the opposite circumferential direction to the second secondary winding 112.

In use, an alternating current signal is supplied to the primary winding 105, which induces a current in each of the secondary windings 110, 112. The amount of current induced in each of the secondary windings 110, 112 depends on the number of turns of the respective secondary winding coil which are magnetically coupled to the flux generated by the alternating current in the primary winding 105. This in turn depends on the axial position of the core member 104. The currents induced in the secondary windings 110, 112 are combined to provide an output signal indicative of the axial position of the core member 104.

A displacement of the core member 104 causes a change in the current induced in the secondary windings 110, 112. Due to the manner in which the secondary windings 110, 112 are wound, a unique output signal depending on the position of the core member 104 is produced. The electrical input and output signals are transmitted to and from the LVDT 102 via cables and a connector for connection to a control or monitoring device (none of which are shown).

The LVDT 102 of FIG. 2 is constructed with the first secondary winding 110 wound in the same direction as the primary winding 105, and the second secondary winding 112 wound in the opposite direction to both the primary winding 105 and the first secondary winding 110. This means that the voltage induced in the first secondary winding 110 is in phase with the voltage supplied to the primary winding 105, whereas the voltage induced in the secondary winding 112 is out of phase with the voltage supplied to the primary winding 105. When the core member 104 is in an extreme position close to the face 111 (i.e. to the left as shown in FIG. 2), a maximum output voltage is induced in the first secondary winding 110 due to the proximity of the core member 104 to the maximum number of turns. At the same time the voltage induced in the second secondary winding 112 is a minimum. When the core member 104 is centred on the intermediate position 115, equal and opposite voltages are induced in the first secondary winding 110 and the second secondary winding 112, giving a combined output voltage of zero. At the other extreme position, close to face 113 (to the right in FIG. 1), a maximum output voltage is induced in the second secondary winding 112, which is out of phase with the voltage supplied to the primary winding 105. The combination of the output voltages induced in the first and second secondary windings 110, 112 as a linear function of displacement of the core member 104 and is shown in FIG. 4.

Referring to FIG. 3, an LVDT 200 is shown having a core member 204, a primary winding 205 and, two secondary windings 210 and 212. A second of the secondary windings 212 is wound radially outwardly of a first of the secondary windings 210 along the entire length of the LVDT 200. The first secondary winding 210 is wound about the primary winding 205 with a profile for which the magnetic integral of the turns varies with axial position according to a sine function. The circumferential direction of the first secondary winding is reversed at a mid-point 215 so that the second half of the sine function cycle follows the same outer profile as the first half of the cycle. The second secondary winding 212 is wound with a profile for which the magnetic integral of the turns varies with axial position according to a cosine function. If the length of the tube 209 allows, multiples of each secondary winding 210, 212 can be added to provide a winding having more than one sinusoidal or cosinusoidal cycle.

The secondary windings 210, 212 are shown radially spaced apart in FIG. 3 for clarity. In practice it is not necessary for the windings to be spaced apart, and both secondary windings 210, 212 may be wound around the tube 209 (i.e. wound on top of one another in the radial direction). Alternatively, the second secondary winding 212 may be wound on a separate moveable tube surrounding the tube 209. This permits adjustment of the relative axial positions between each of the secondary windings 210, 212 for calibration and to improve accuracy.

In use, an alternating current (or voltage) signal is supplied to the primary winding 205, which induces a current (or voltage) in each of the secondary windings 210, 212 in the same way as the linear LVDT 102 of FIG. 2. The induced currents/voltages in the secondary windings 210, 212 provide output signals indicative of the sine and cosine of an angle which is proportional to the axial displacement of the core member 204. The output from the first secondary winding 210 has a sinusoidal dependency on linear displacement and the output from the second secondary winding 212 has a cosinusoidal dependency on linear displacement. FIG. 5 is a graph showing output voltage signals (Vsine output, Vcosine output) as a function of axial displacement of the core member 204.

The output signal can be combined in the form of a transfer function. A suitable transfer function in this case is arctan (sine/cosine). This provides an output signal proportional to the angle (degrees or radians) corresponding to (and having a linear dependency on) displacement of the core member 204. The transfer function output is shown in FIG. 6.

The outputs from the two secondary windings are as follows:
Output (Vcos)=Vsupply×Transformation Ratio (K)×cos Y
Output (Vsin)=Vsupply×Transformation Ratio (K)×sin Y
Where Y is the displacement distance of the core 204 and Vsupply is the voltage supplied to the primary winding. The transformation ratio K is nominally constant over the displacement stroke and is given by:

$$\frac{{( {( V sin )}^{2} + {( V cos )}^{2} )}^{1 / 2}}{Vsupply}$$

This can be used as an error checking function for system integrity between certain predefined limits.

Vcos and Vsin can be either in phase rms components with respect to primary input, or rms only.

The transfer function is Arctan (Vsin/Vcos). This is shown in FIG. 6 as having a linear (straight-line) relationship with respect to linear stroke position. However, depending on the actual geometry of secondary windings, the transfer function may have a different (non-linear) relationship. For example, the windings may be arranged to provide a transfer function having two distinct (i.e. different gradient) straight-line regions, or to provide a continuously varying (i.e. curved) relationship.

The transformation ratio K is nominally constant over the displacement stroke and is given by:

$$\frac{{( {( V sin )}^{2} + {( V cos )}^{2} )}^{1 / 2}}{Vsupply}$$

This can be used as an error checking function for system integrity between certain predefined limits.

Vcos and Vsin can be either in phase rms components with respect to primary input, or rms only.

Defining the output in terms of the transfer function is advantageous because it provides a degree of isolation from common mode errors such as variations in the input voltage, frequency or temperature. The transfer function reduces supply and temperature variation effects because changes that are proportional to both sine and cosine are cancelled out.

The first and second secondary windings 210, 212 can be extended to provide outputs over four or more quadrants of the trigonometric sine and cosine functions. This means that the output is not limited to mimic 360 degrees of rotation or less, but may represent any angle of rotation or any number of rotational equivalent cycles.

An additional pair of secondary windings may be included on top of the first and second secondary windings 210, 212. These additional windings may be used to indicate in which rotational equivalent cycle (i.e. set of 4 quadrants) the core member 204 is located at any time (i.e. for any given value of Vcos and Vsin output). For example if the first and second secondary windings 210, 212 comprised 16 quadrants (4 cycles), the additional secondary windings would provide a signal to indicate which of the four cycles the core member 204 is in. In order to ascertain the appropriate rotational equivalent cycle the additional pair of secondary windings may be configured to provide additional sine and cosine data, but on a larger axial scaling (e.g. 1 quadrant corresponding to 4 quadrants of the first and second secondary windings 210, 212).

Alternatively, the additional secondary windings may be similar to those of a conventional 1 vdt, as shown in FIG. 2. For example, the additional secondary windings may be arranged over 8 quadrants of the first and second secondary windings 210, 212, centred at the end of the fourth quadrant and start of the fifth quadrant. If Sec1 is the output from one of the additional secondary windings and Sec2 the output from the other, then these may be combined as Sec1−Sec2, or (Sec1−Sec2)/(Sec1+Sec2) to provide an indication of the rotational cycle in which the core member is located.

Further alternative arrangements of additional secondary windings may be used. For example a single additional winding may be configured with an axially varying number of coil turns so as to provide an output that can be used to determine which rotational equivalent cycle the core member is in.

The linear LVDT 102 of FIG. 2 has substantially linear magnetic coil integrals with position and the secondary windings 110 and 112 are wound oppositely in series and connected at the intermediate position 115. In contrast, the sine/cosine LVDT 200 of FIG. 3 has magnetic coil integrals that vary sinusoidally with position and the secondary windings 210 and 212 are not wound in series, or connected at the intermediate position 215. Instead, the secondary windings 210 and 212 are wound separately around the tube 209. They have the same physical form, but they are offset to each other by a quarter of a sine wave phase. The sine/cosine LVDT 200 produces a linear output for an appropriately defined transfer function, as exemplified in FIG. 6, even though the individual voltages induced in the secondary windings are non-linear. The sine/cosine LVDT 200 can be used to mimic a rotary resolver sensor output, and is thus suitable for use in existing control systems designed for rotary resolver outputs.

1. A transducer comprising:
a core member moveable along a path;
a primary winding; and
at least one secondary winding,
whereby an AC signal supplied to said primary winding induces an output signal in said secondary winding dependent upon the position of said core member along said path,
wherein said windings comprise turns of electrical conductors distributed relative to one another such that said output signal induced is indicative of a trigonometric function of the displacement of said core member along said path.

2. A transducer according to claim 1, wherein the core member is of a magnetically permeable material so as to enhance inductive coupling of the primary and secondary windings.

3. A transducer according to claim 1, wherein the trigonometric function is a sine or a cosine function so as to provide an output signal indicative of an angle corresponding to displacement of the core member along said path.

4. A transducer according to claim 3, wherein the transducer has a first secondary winding configured to provide an output indicative of a sine function of the displacement of the core member, and a second secondary winding configured to provide an output indicative of a cosine function of the displacement of the core member.

5. A transducer according to claim 4, wherein the sine function and the cosine function are combined to provide a transfer function output signal.

6. A transducer according to claim 5, wherein the transfer function is arctan(sine/cosine).

7. A transducer according to claim 4, wherein the first and second secondary windings are extended to provide output signals of the trigonometric functions corresponding to more than 360 degrees.

8. A transducer according to claim 7, wherein the windings are extended to provide output signals over a plurality of 360 degree cycles.

9. A transducer according to claim 8, wherein at least one further secondary winding is included in addition to the first and second secondary windings so as to provide a further output signal to indicate in which 360 degree cycle the core member is located.

10. A transducer comprising:
a core member moveable along a path;
a primary winding; and
first and second secondary windings,
whereby an AC signal supplied to said primary winding induces an output signal in each of said first and second secondary windings dependent upon the position of said core member along said path,
wherein said windings comprise turns of electrical conductors distributed relative to one another such that said output signal provided by said first secondary winding is indicative of a first trigonometric function of the displacement of said core member along said path and said output signal provided by said second secondary winding is indicative of a second trigonometric function of the displacement of said core member along said path, said output signals from said first and second secondary windings being combined to provide a transfer function output signal.

11. A transducer according to claim 10, wherein the first trigonometric function is a sine function and the second trigonometric function is a cosine function.

12. A transducer according to claim 11, wherein the transfer function is arctan (sine/cosine).

13. A transducer according to claim 10, wherein the first and second secondary windings are extended to provide output signals of the trigonometric functions corresponding to more than 360 degrees.

14. A transducer according to claim 13, wherein the windings are extended to provide output signals over a plurality of 360 degree cycles.

15. A transducer according to claim 14, wherein at least one further secondary winding is included in addition to the first and second secondary windings so as to provide a further output signal to indicate in which 360 degree cycle the core member is located.

16. A transducer comprising:
a core member moveable along a path;
a primary winding;
a first pair of secondary windings; and
a second pair secondary windings;
whereby an AC signal supplied to said primary winding induces an output signal in each of said secondary windings dependent upon the position of said core member along said path,
wherein said windings comprise turns of electrical conductors distributed relative to one another such that said output signal provided by said first pair of secondary windings is related to a trigonometric function of the displacement of said core member along said path corresponding to a plurality of 360 degree cycles and said output of said second pair of secondary windings is indicative of which of said plurality of 360 degree cycles the core member is located in.
